(19) United States
(12) Patent Application Publication
(10) Pub. No.: US 2024/0291864 A1
(43) Pub. Date: Aug. 29, 2024

(54) INTRUSION DETECTION BASED ON IMPLICIT ACTIVE LEARNING

(71) Applicant: International Business Machines Corporation, Armonk, NY (US)

(72) Inventors: Oded Sofer, Midreshet Cen Gurion (IL); Guy Galil, Jerusalem (IL)

(21) Appl. No.: 18/115,056

(22) Filed: Feb. 28, 2023

(51) Int. Cl. H04L 9/40

(52) U.S. Cl. CPC H04L 63/1491; H04L 63/1433; H04L 63/205

(57) ABSTRACT

A computer-implemented method comprising: automatically monitoring a honeypot trap environment, to capture activity data within the honeypot trap environment, wherein the honeypot trap environment comprises a plurality of software and hardware resources that are intended to attract attempts at unauthorized use of the honeypot trap environment; automatically extracting, from the captured activity data, a plurality of attributes representing entities, events, and relations between the entities and events; automatically applying an analytics suite to identify specific combinations of the attributes as representing a likelihood of being associated with an unauthorized intrusion attempt into the honeypot environment; automatically assigning a risk score to each of the specific combinations, wherein the risk score reflect the likelihood of being associated with an unauthorized intrusion attempt into the honeypot environment; and automatically generating at least one security rule for an intrusion detection and prevention system, based on at least one of the specific combinations.

### BACKGROUND

The present application relates to the field of computer system security.

Computer systems are vulnerable to a variety of exploits that can compromise their intended operations. Overtime, attackers become more familiar with the defense mechanisms of current detection methods, and are developing sophisticated dynamic attack methods that are updated frequently.

To improve computer system security, organizations have sought solutions such as firewalls, Virtual Private Networks (VPNs), and intruder detection systems (IDSs), which monitor unauthorized access or activities in computer systems or networks. Within this context, honeypot traps can be used to gather information by luring potential attackers into a controlled environment, by presenting a more visible and seemingly more vulnerable resource than the network itself. Honeypots provide a single point for security professionals to monitor for evidence of anomalous activity, and to gather and retain data pertaining to suspected attacks. A honeypot's main advantage lies in the fact that any activity on a honeypot can be immediately defined as potentially malicious. The gathered information can then be used to identify and defeat attacks by unknown intruders, for which no prior knowledge is available regarding methods of operation.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in an embodiment, a computer-implemented method comprising: automatically monitoring a honeypot trap environment, to capture activity data within the honeypot trap environment, wherein the honeypot trap environment comprises a plurality of software and hardware resources that are intended to attract attempts at unauthorized use of the honeypot trap environment; automatically extracting, from the captured activity data, a plurality of attributes representing entities, events, and relations between the entities and events; automatically applying an analytics suite to identify specific combinations of the attributes as representing a likelihood of being associated with an unauthorized intrusion attempt into the honeypot environment; automatically assigning a risk score to each of the specific combinations, wherein the risk score reflect the likelihood of being associated with an unauthorized intrusion attempt into the honeypot environment; and automatically generating at least one security rule for an intrusion detection and prevention system, based on at least one of the specific combinations.

There is also provided, in an embodiment, a system comprising at least one hardware processor; and a non-transitory computer-readable storage medium having stored thereon program instructions, the program instructions executable by the at least one hardware processor to: automatically monitor a honeypot trap environment, to capture activity data within the honeypot trap environment, wherein the honeypot trap environment comprises a plurality of software and hardware resources that are intended to attract attempts at unauthorized use of the honeypot trap environment, automatically extract, from the captured activity data, a plurality of attributes representing entities, events, and relations between the entities and events, automatically apply an analytics suite to identify specific combinations of the attributes as representing a likelihood of being associated with an unauthorized intrusion attempt into the honeypot environment, automatically assign a risk score to each of the specific combinations, wherein the risk score reflect the likelihood of being associated with an unauthorized intrusion attempt into the honeypot environment, and automatically generate at least one security rule for an intrusion detection and prevention system, based on at least one of the specific combinations.

There is further provided, in an embodiment, a computer program product comprising a non-transitory computer-readable storage medium having program instructions embodied therewith, the program instructions executable by at least one hardware processor to: automatically monitor a honeypot trap environment, to capture activity data within the honeypot trap environment, wherein the honeypot trap environment comprises a plurality of software and hardware resources that are intended to attract attempts at unauthorized use of the honeypot trap environment; automatically extract, from the captured activity data, a plurality of attributes representing entities, events, and relations between the entities and events; automatically apply an analytics suite to identify specific combinations of the attributes as representing a likelihood of being associated with an unauthorized intrusion attempt into the honeypot environment; automatically assign a risk score to each of the specific combinations, wherein the risk score reflect the likelihood of being associated with an unauthorized intrusion attempt into the honeypot environment; and automatically generate at least one security rule for an intrusion detection and prevention system, based on at least one of the specific combinations.

In some embodiments, the honeypot trap environment comprises a plurality of software and hardware resources that are intended to attract attempts at unauthorized use of the honeypot trap environment.

In some embodiments, the entities comprise any one or more processes, objects, artifacts, files, directories, database servers, database tables, database collections, registries, sockets, and network resources.

In some embodiments, the events comprise any one or more of a system level or application level action that can be associated with one or more of the entities.

In some embodiments, the events are selected from the group consisting of: create directory, open file, read (‘SELECT’) from a database table, delete from a database table, stored procedure, modify data in a file, delete a file, copy data in a file, execute process, connect on a socket, accept connection on a socket, fork process, create thread, execute thread, start/stop thread, and send/receive data through socket or device.

In some embodiments, the attributes comprise connection attributes selected from the group consisting of: User ID, source program, client Internet Protocol (IP) address, server IP, domain name, Uniform Resource Locater (URL), Uniform Resource Identifier (URI), Unique IDentifier (UID), Media Access Control (MAC) address, DB (database) User, service name, client host, client operating system, user ID, port numbers and ranges, and/or protocol used.

In some embodiments, the attributes comprise activity attributes selected from the group consisting of: Commands, SQL commands, objects accessed, number and frequency of probe requests within a specified time period, time of day of probe requests, data patterns, unique strings, RegEx, keywords, specific syntax, login failures. authentication failures, and errors.

In some embodiments, the generating comprises one of: updating an existing security rule, and formulating a new security rule.

In some embodiments, the at least one security rule comprises (i) a conditional part comprising a set of conditions to be met for the security rule to be triggered, and (ii) an action part, comprising a set of actions to be taken when the security rule is triggered.

In some embodiments, the set of actions are one of: halting an involved process, issuing an alert, moving an involved process to a sandbox for further evaluation, dropping an on-going network session, halting an on-going disk operation, blocking one or more users or activities, quarantining one or more nodes or sections of a network, and adding users and other entities to a blacklist.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 is a block diagram of an exemplary computing environment for the execution of at least some of the computer code involved in performing the inventive methods.

FIG. 2 is a flowchart of a method for automatically gathering computer system intrusion-related information, automatically analyzing the gathered information to extract multiple categories of intrusion-related attributes, and automatically generating and/or updating intrusion detection policies and rules, based on the extracted attributes.

FIG. 3 illustrates an exemplary honeypot environment for the execution of at least some of the computer code involved in performing the inventive methods.

### DETAILED DESCRIPTION

Disclosed herein is a technique, embodied in a computer-implemented method, a system, and a computer program product, for automatically gathering computer system intrusion-related information, automatically analyzing the gathered information to extract multiple categories of intrusion-related attributes, and automatically generating and/or updating intrusion detection policies and rules, based on the extracted attributes.

In some embodiments, the present technique may provide for automating the generation and/or updating of intrusion detection and prevention security policy and rules, based on information gathered with respect to intrusion attempts within a dedicated honeypot environment. For instance, the present technique may provide for automated generating of a security policy and rules for a network security system, such as an intrusion detection system (IDS). An IDS is a software application that monitors network or system activities for malicious activities or policy violations, logs related information and activities, and may apply defined security policy and rules to stop suspected intrusion attempts. The automatically generated and/or updated policy and rules may be implemented by an IDS in near-real time, to ensure robust protection against rapidly evolving threats.

In some embodiments, the present technique provides for configuring and provisioning a dedicated honeypot trap environment comprising one or more information systems (e.g., database instances or network sites), configured to ‘bait’ attackers and attract attempts at unauthorized access and use. For example, the present technique may provide for constructing one or more information systems that appear to be, from the perspective of an unauthorized user, a legitimate computing system or part of one, and to have the same characteristics, information, and/or resources as a normal computing environment which may be of value to attackers. In some embodiments, the present technique provides for operating the created honeypot environment as an actual computer system available for access through one or more networks, a cloud infrastructure, the Internet, and the like.

In some embodiments, the honeypot environment created within the context of the present technique may comprise any suitable software and/or hardware resources that are intended to attract attempts at unauthorized use of the information systems. In some examples, the honeypot environment can include real and simulated network resources, such as simulated virtual machines and simulated storage. In some embodiments, the honeypot environment may be configured to mimic legitimate resources or important data. In some embodiments, the honeypot environment may be created to mimic the appearance and content of real computer systems or network sites, and may comprise synthetic data or other information arranged in a structure that appears to be similar to actual sensitive and critical information included in database systems. For example, the honeypot environment may include sites that mimic a customer billing system, a CRM (Customer Relationship Management) system, and the like.

In some embodiments, some of the various instances or components of the honeypot environment may have different security and/or access levels associated therewith, and/or include deliberate security vulnerabilities. In some embodiments, the honeypot environment may comprise a seemingly easy or attractive intrusion point into a network. For instance, some of the instances may have ports that respond to a port scan, or weak passwords.

In some embodiments, the present technique provides for monitoring and detecting unauthorized access attempts to the honeypot environment. The present technique then provides for capturing and storing a plurality of data regarding any such unauthorized access attempts, including, but not limited to:
Connection attributes: User ID, source program, client host, client IP addresses, client operating system, operating system user ID, port numbers and ranges, domain names, URLs, and/or protocol used.
Activity attributes: Commands executed, objects accessed, number and frequency of probe requests within a specified time period by a user, time of day of probe requests, unique strings, keywords, syntax, login failures, authentication failures, errors, syntax errors.
Combinations and sequences: Unique combinations of connection attributes, activity attributes, and errors, e.g., a combination of user ID and source program.

In some embodiments, the captured data may represent network data traffic, and may refer to a set of packets, i.e., communication structures for communicating information, such as a protocol data unit (PDU), a network packet, a datagram, a segment, a message, a block, a cell, a frame, and/or another type of formatted or unformatted unit of data capable of being transmitted via a computer data network.

In some embodiments, the present technique then provides for applying an analytics suite to analyze the captured data. The analytics suite is configured to identify specific attributes, as well as patterns, sequences, and/or combinations of attributes, which may be identified as a Security Indication representing a specific likelihood of being associated with an unauthorized intrusion into the honeypot environment. In some embodiments, each Security Indication may represent one or more individual attributes, any combination of attributes, any sequence of actions or events, any behavioral pattern, any signature, and/or any other combination of these elements. Thus, a Security Indication may be a simple check or a complex pattern of entities and events.

It should be noted that emerging cyber-attack methods, such as advanced persistent threat, have become increasingly more sophisticated, and usually involve multiple processes. To achieve their attack goals, these comprehensive attacks usually consist of long attack vectors that exploit multiple processes on a single host, or on multiple hosts. Thus, understanding inter-process behavior is important to identifying attacks and reducing false alarms. Accordingly, within the context of the present disclosure, an attack or intrusion into a computer system may involve a plurality of system entities, connected by a plurality of relationships, events or actions. For example, two or more entities can be connected by one or more processes, files, ports, network sockets, registries, etc. Entities are generally processes or an object (e.g., file, directory, registry, socket, pipe, database server, database table, database collection, character device, block device, or other type). Events and/or actions are typically system-level or application-level events or actions that can be associated with an entity, e.g., operating system processes, files, network connections, system calls, create directory, open file, read (‘SELECT’) from a database table, delete from a database table, stored procedure, modify data in a file, delete a file, copy data in a file, execute process, connect on a socket, accept connection on a socket, fork process, create thread, execute thread, start/stop thread, and send/receive data through socket or device.

Because a typical attack may comprise a complex sequence of actions, and follow one or more known attack methods, the analytics suite will search and detect specific patterns and/or signatures which may identify the attack methods involved, based on sequences or combination of entities, events and actions, specific signatures (e.g., unique characters, strings, keywords, etc.), and/or specific errors involved. In some embodiments, the analytics suite may compare and match specific attributes or sequences thereof to a library of known attacks comprising preconfigured and predetermined attack patterns and signatures, such as specific byte sequences or known instruction sequences used in attacks.

Accordingly, the present technique provides for an efficient and systematic process to record suspected intrusion activities within the honeypot environment, and to associate extracted attributes and activities, as represented in the recorded events, with recognized patterns. In some embodiments, the present technique provides for comparing the extracted attributes and activities with predefined malicious behavior patterns for detection. In some embodiments, the extracted attributes and activities include, but are not limited to, control flow and information exchange via channels, such as files, sockets, messages, shared memory and the like. For example, attributes, and sequences and combinations of attributes, can be defined in a manner that analyzes system level activities on one or more of the above dimensions. Thus, a frequency attribute can be defined as a source process invoking a certain event multiple times within a single time window. In other cases, the analytics suite can identify events between two entities, a combination of specific events within a single execution path, or a subset of events taking place across different execution paths.

In some embodiments, the analytics suite may comprise machine learning-based techniques, such as classification and clustering analyses, applied over extracted attributes and activities, to identify behavioral patterns and to associate attributes and activities into defined behavioral clusters. In some embodiments, the present technique may also apply statistical analyses, aggregate-based analyses, network analyses, and/or event timeline analyses.

In some embodiments, the present technique then provides for assigning a risk score to each of the Security Indications identified by the analytics suite, consistent with the level of risk represented by each Security Indication. Thus, Security Indications that are more suspicious or more likely to be malicious are assigned higher risk scores than those which may be relatively less risky. In some embodiments, the risk scores can be a predefined value, or can be defined by a category (e.g., low risk, medium risk, high risk). In some embodiments, individual risk scores for Security Indications may be aggregated to represent a cumulative risk score of a complex pattern of behavior involving multiple Security Indications. Thus, individual risk scores may be added up for a total risk score representing the overall risk of the specific behavior pattern comprising two or more individual Security Indications.

In some embodiments, the present technique then provides for a policy generator configured to create a security and intrusion detection and prevention policy, based on the set of identified Security Indications.

In some embodiments, the security policy outlines a set of security rules which govern computer system access, web-browsing habits, use of passwords and encryption, email attachments, and/or the like. In some embodiments, the present technique provides for a policy generator configured to generate a security policy comprising security rules, based on the set of identified Security Indications. In some embodiments, the policy generator is configured to generate new rules, e.g., based on new or updated Security Indications, or to modify and/or update existing rules.

Each of the rules may comprise a conditional part comprising a set of conditions to be met for the rule to be triggered, and an action part, comprising a set of measures to be taken in case the rule is triggered. In some embodiments, the action portion of a rule may be determined based on the risk score associated with its underlying one or more Security Indications. For example, a rule associated with a relatively low risk score may result in an action consisting of logging the violating event in a log server, generating a report, issuing a notification, and/or updating a whitelist. Conversely, a rule associated with a relatively high risk score may result in an action consisting of more severe action, such as halting the involved processes, issuing alerts and notifications, moving the involved processes to a sandbox for further evaluation, dropping on-going network sessions, halting on-going disk operations, blocking certain users or activities, quarantining one or more nodes or sections of a network, adding users and other entities to a blacklist, etc.

In some embodiments, security rules may be fully-matching, i.e., rules that are only triggered by an identical set of events; partially overlapping rules, which accept a common subset of events; and inclusive rules, where one rule can potentially satisfy only a subset of all events accepted by another rule. In some embodiments, rules can range in complexity from a simple check of access privileges, to rules representing complex patterns of entities and events.

In some embodiments, the techniques outlined hereinabove, including data capture, data analytics, and policy generation, may be performed iteratively, in real-time or near real-time, to continuously capture new data, identify new Security Indications, and generate new security rules and/or update existing security rules.

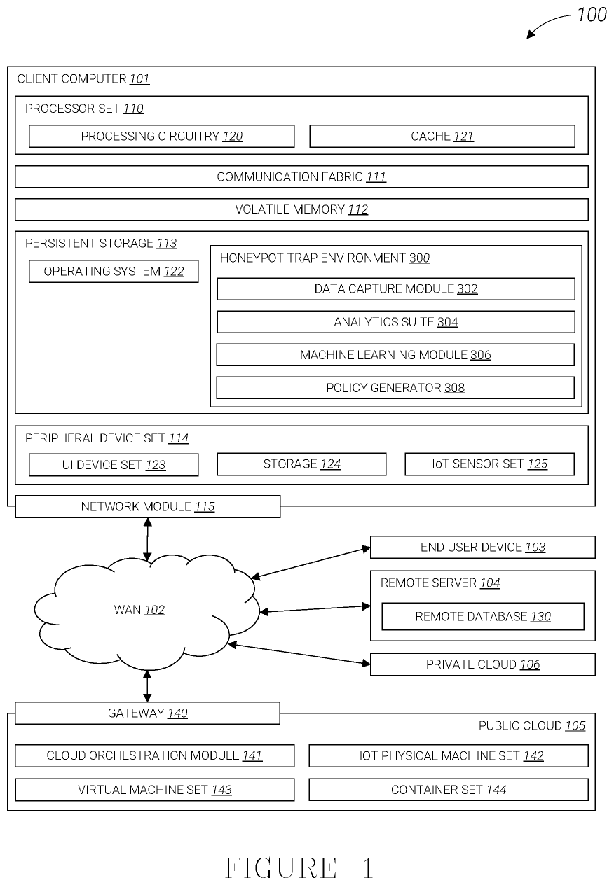

Reference is now made to FIG. 1, which shows a block diagram of an exemplary computing environment 100, containing an example of an environment for the execution of at least some of the computer code involved in performing the inventive methods, such as honeypot trap environment 300, comprising one or more modules, such as data capture module 302, analytics suite 304, machine learning module 306, and/or policy generator 308. In addition to honeypot trap environment 300, computing environment 100 includes, for example, a computer 101, a wide area network (WAN) 102, an end user device (EUD) 103, a remote server 104, a public cloud 105, and/or a private cloud 106. In this example, computer 101 includes a processor set 110 (including processing circuitry 120 and a cache 121), a communication fabric 111, a volatile memory 112, a persistent storage 113 (including an operating system 122 and honeypot trap environment 300, as identified above), a peripheral device set 114 (including a user interface (UI), a device set 123, a storage 124, and an Internet of Things (IoT) sensor set 125), and a network module 115. Remote server 104 includes a remote database 130. Public cloud 105 includes a gateway 140, a cloud orchestration module 141, a host physical machine set 142, a virtual machine set 143, and a container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network and/or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one or more computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the method(s) specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored by honeypot trap environment 300 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open source Portable Operating System Interface type operating systems that employ a kernel. The code included in honeypot trap environment 300 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the Internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as a network interrace controller (NIC), a modem, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through the hardware included in network module 115.

WAN 102 is any wide area network (for example, the Internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the Internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As will be seen, the techniques described herein may operate in conjunction within the environment illustrated in FIG. 1, in which client machines communicate with an Internet-accessible Web-based portal executing on a set of one or more machines. End users operate Internet-connectable devices (e.g., desktop computers, notebook computers, Internet-enabled mobile devices, or the like) that are capable of accessing and interacting with the portal. Typically, each client or server machine is a data processing system comprising hardware and software, and these entities communicate with one another over a network, such as the Internet, an intranet, an extranet, a private network, or any other communications medium or link. A data processing system typically includes one or more processors, an operating system, one or more applications, and one or more utilities. The applications on the data processing system provide native support for Web services including, without limitation, support for HTTP, SOAP, XML, WSDL, UDDI, and WSFL, among others. Information regarding SOAP, WSDL, UDDI and WSFL is available from the World Wide Web Consortium (W3C), which is responsible for developing and maintaining these standards; further information regarding HTTP and XML is available from Internet Engineering Task Force (IETF). Familiarity with these standards is presumed.

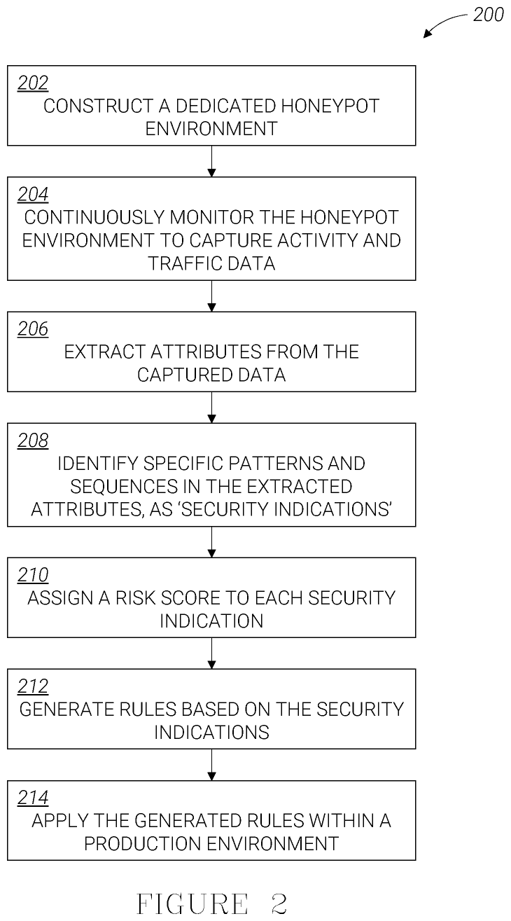

The instructions of honeypot trap environment 300 are now discussed with reference to the flowchart of FIG. 2, which illustrates a method 200 for automatically gathering computer system intrusion-related information, automatically analyzing the gathered information to extract multiple categories of intrusion-related attributes, and automatically generating and/or updating intrusion detection policies and rules, based on the extracted attributes, in accordance with an embodiment of the present technique.

Steps of method 200 may either be performed in the order they are presented or in a different order (or even in parallel), as briefly mentioned above, as long as the order allows for a necessary input to a certain step to be obtained from an output of an earlier step. In addition, the steps of method 200 are performed automatically (e.g., by computer 101 of FIG. 1, and/or by any other applicable component of computing environment 100), unless specifically stated otherwise.

Method 200 begins in step 202, wherein the present technique provides for configuring and provisioning a dedicated honeypot environment.

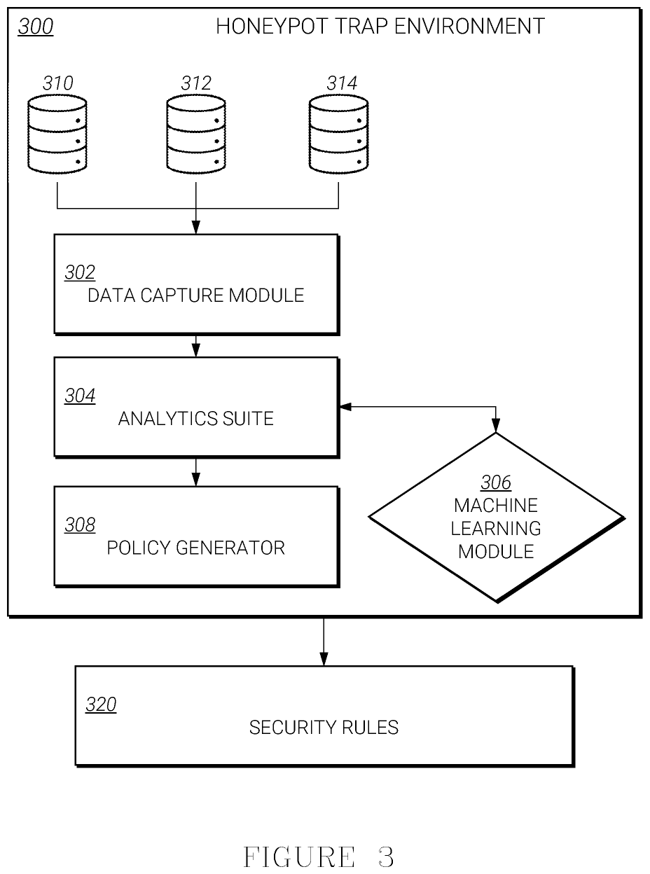

FIG. 3 is a detailed depiction of exemplary honeypot trap environment 300 shown in FIG. 1. In pertinent part, the honeypot trap environment 300 may comprise, e.g., a packet capture appliance 310, and event logger 312, and/or a native audit system 314, associated with data capture module 302. In addition, honeypot environment 302 comprises an analytics suite 304, a machine learning module 306, and a policy generator 308.

The packet capture appliance 310, event logger 312, and/or native audit system 314 are configured as network appliances, or they may be configured as virtual appliances. Packet capture appliance 310 is operative to capture packets off a network connection (using known packet capture Application Programming Interfaces (APIs) or other known techniques), and to provide such data (e.g., real-time log event and network flow) to data capture module 302, which may store the data on persistent storage 113. In some embodiments, event logger 312 is configured to record and time-stamp events occurring in the operation of the honeypot environment 300, and to provide such data to data capture module 302. In some embodiments, native audit system, 314 is configured to log details about data access to data stored within a database, and to provide such data to data capture module 302.

Data capture module 302 makes the captured and stored data available for analysis by the analytics suite 304. A packet capture appliance operates in a session-oriented manner, capturing all packets in a flow, and indexing metadata and payloads to enable fast search-driven data exploration.

In some embodiments, honeypot trap environment 300 comprises one or more information systems (e.g., database instances or network sites), configured to ‘bait’ attackers and attract attempts at unauthorized access and use. In some embodiments, the present technique provides for operating the created honeypot environment as an actual computer system available for access through one or more network, a cloud infrastructure, the internet, and the like.

In some embodiments, the honeypot environment created within the context of the present technique may comprise any suitable software and hardware resources that are intended to attract attempts at unauthorized use of the information systems. In some examples, the honeypot environment can include real and simulated network resources, such as simulated virtual machines and simulated storage. In some embodiments, the honeypot environment may be configured to mimic legitimate resources or important data. In some embodiments, the honeypot environment may be created to mimic the appearance and content of real computer systems or network sites, and may comprise synthetic data or other information arranged in a structure that appears to be similar to actual sensitive and critical information included in database systems. For example, the honeypot environment may include sites that mimic a customer billing system, a CRM (Customer Relationship Management) system, and the like.

In some embodiments, some of the various instances or components of the honeypot environment may have different security and/or access levels associated therewith, and/or include deliberate security vulnerabilities. In some embodiments, the honeypot environment may comprise a seemingly easy or attractive intrusion point into a network. For instance, some of the instances may have ports that respond to a port scan, or weak passwords.

In step 204, the instructions of data capture module 302 may cause honeypot trap environment 300 to continuously monitor activities within honeypot trap environment 300 comprising unauthorized access attempts to the honeypot environment. In some embodiments, data capture module 302 is responsible for continuously capturing all activities and data traffic exchanged between honeypot trap environment 300 and any external user, device and/or network, using, e.g., one or more of packet capture appliance 310, event logger 312, and/or a native audit system 314 shown in FIG. 2. In some embodiments, the captured data may represent network data traffic, and may refer to a set of packets, i.e., communication structures for communicating information, such as a Protocol Data Unit (PDU), a network packet, a datagram, a segment, a message, a block, a cell, a frame, and/or another type of formatted or unformatted unit of data capable of being transmitted via a computer data network.

In some embodiments, data capture module 302 may be configured to continuously monitor all activities and events within honeypot trap environment 300, e.g., via system call monitoring, kernel hooking, system monitoring services.

In some embodiments, data capture module 302 is configured to parse the captured data into a plurality of data points, which may comprise, but are not limited to, any data regarding entities, events, and actions within honeypot trap environment 300, including any actions and events relating to operating system or other processes, network connections, system, calls, files, ports, network sockets, registries, objects, etc.

In some embodiments, data capture module 302 may be configured to store the captured and parsed data in a dedicated data repository, located, e.g., on persistent storage 113.

In step 206, data capture module 302 may be configured to extract attributes, actions, and events from the data captured and parsed in step 202. In some embodiments, the attributes, actions, and events extracted by data capture module 302 from the captured traffic data may comprise, but are not limited to:
Connection attributes:
   User ID,
   source program,
   Client Internet Protocol (IP) address,
   server IP
   Uniform Resource Locater (URL),
   Uniform Resource Identifier (URI),
   Unique IDentifier (UID),
   Media Access Control (MAC) address,
   DB User,
   service name,
   client host,
   client operating system,
   user ID,
   port numbers and ranges,
   domain name, and/or
   protocol used.
Activity attributes:
   Commands,
   SQL commands,
   objects accessed,
   number and frequency of probe requests within a specified time period,
   time of day of probe requests,
   data pattern,
   unique strings,
   regex,
   keywords,
   specific syntax,
   login failures,
   authentication failures, and/or
   errors.
Combinations and sequences: Unique combinations of connection attributes, activity attributes, and errors, e.g., a combination of user ID and source program.

Table 1 below provides an exemplary list of certain attributes, actions and events which may be extracted by data capture module 300 in step 204:

TABLE 1

| ATTRIBUTE | DESCRIPTION |
|---|---|
| Duration | Duration (in seconds) of the connection |
| Protocol type | Type of the protocol used (e.g., TCP, UDP, |
| | etc.) |
| Service | Network service on the destination (HTTP, |
| | Telnet) |
| Flag | Error status of the connection |
| Source bytes | Total data bytes from source to destination |
| Destination bytes | Total data bytes from destination to source |
| Wrong fragments | Number of “wrong” fragments |
| Urgent | Number of urgent packets |
| Failed logins | Number of failed login attempts |
| Login status | 1 if successfully logged in; 0 otherwise |
| Root accesses | Number of “root” accesses |
| File creations | Number of file creation operations |
| Shell prompts | Number of shell prompts |
| Access control files | Number of operations on access control files |
| Outbound commands | Number of outbound commands in an FTP |
| | session |
| Guest login | Login is a guest login |
| Connection count | Number of connections to same host within a |
| | time window |
| Service count | Number of connections to same service within |
| | a time window |
| SYN error rate | Ratio of connections that have SYN errors |
| Service rate | Ratio of connections to different services |
| Host rate | Ratio of connections to different hosts |
| Destination host count | Count of destination hosts |

In some embodiments, data capture module 302 may be configured to assign a tag or label to each attribute, which describes its category and properties.

In step 208, an analytics suite 304 may be applied to the attributes extracted in step 204, to identify specific attributes, as well as patterns, sequences, and combinations of attributes, which may be defined as a Security Indication representing a specific likelihood of being associated with an unauthorized intrusion into the honeypot environment. In some embodiments, each Security Indication may comprise a unique combination of entities, events, actions, keywords, strings, and/or errors, which any be arranges in a particular sequence.

In some embodiments, analytics suite 304 may be configured to apply any suitable one or more analyses, techniques, and algorithms, including, but not limited to, behavioral analyses; decision trees; neural networks; fuzzy logic; data and process mining; Natural Language Processing (NLP) algorithms; supervised, semi-supervised, and/or unsupervised machine learning methods; machine learning-based classification methods; machine learning-based anomaly detection methods; statistical analyses; pattern recognition algorithms; and clustering algorithms. In some embodiments, machine learning module 306 may be utilized to apply any machine learning-based algorithms employed by analytics suite 304.

In some embodiments, analytics suite 304 may be configured to identify specific meaningful patterns and sequences of attributes and activities within the data extracted by data capture module 302. Each of these patterns and sequences typically represents a history of computation, including entities and events associated with attacks or threats. The patterns or sequences will identify any involved entities (any system element that can either send or receive information, e.g., processes, files, network sockets, registry keys, sensors, etc.), and any involved events (any information/control flow that connects two or more entities, e.g., file read, process fork, etc.). In some embodiments, a pattern or sequence identified by analytics suite 304 may represent one or more elements (e.g., one or more entities), and the elements relations (e.g., when an entity connects to an event).

In some embodiments, analytics suite 304 may be configured to identify specific meaningful patterns and sequences of attributes and activities within the data extracted by data capture module 302, based on matching the activity attributes against known malicious or suspicious behavior. In some embodiments, pattern matching may be based on one or more pattern matching techniques and algorithms. In some embodiments, the matching operations are informed by and based on existing attack information available in, e.g., a repository or knowledge center of threat reports and information derived based on evaluations and analysis of known threats.

In step 210, analytics suite 304 may be configured to assign a risk score to each of the Security Indications identified in step 208. In some embodiments, the risk score represents the level of risk of each Security Indication. For example, Security Indications that are more suspicious or more likely to be malicious are assigned higher risk scores than Security Indications which may be relatively less risky.

In some embodiments, the risk scores can be a predefined value (e.g., a number between 1-5 or 1-100), a percentage score (e.g., between 0-100%), or can be defined by a discrete category (e.g., low risk, medium risk, high risk).

In some embodiments, individual risk scores associated with two or more Security Indications may be aggregated to represent a cumulative risk score of a complex pattern of behavior involving those two or more Security Indications. Thus, individual risk scores may be added up for a total risk score representing the overall risk of the specific behavior pattern comprising two or more individual Security Indications.

In step 212, policy generator 208 may be configured to generate a security policy, or update an existing security policy, wherein the security policy outlines a set of security rules which govern computer system intrusion and detection within a production environment.

In some embodiments, policy generator 208 may be configured to generate new security rules 320 (shown in FIG. 3), and/or update or modify existing security rules, for a security policy, wherein each of the security rules is based on one, or a combination or two or more, Security Indications.

In some embodiments, each generated security rule 320 may comprise a conditional part comprising a set of conditions to be met for the rule to be triggered, and an action part, comprising a set of measures to be taken in case the rule is triggered. In some embodiments, the action portion of a rule may be determined based on the risk score associated with its underlying one or more Security Indications. For example, a rule associated with a relatively low risk score may result in an action consisting of logging the violating event in a log server, generating a report, issuing a notification, and/or updating a whitelist. Conversely, a rule associated with a relatively high risk score may result in an action consisting of more severe action, such as halting the involved processes, issuing alerts and notifications, moving the involved processes to a sandbox for further evaluation, dropping on-going network sessions, halting on-going disk operations, blocking certain users or activities, quarantining one or more nodes or sections of a network, adding users and other entities to a blacklist, etc.

Table 2 below lists several exemplary security rules 320 which may be generated by policy generator 208, based on Security Indications identified in step 208.

TABLE 2

| RULE | ACTION |
|---|---|
| [Request Resource = A] AND [String = %XYZ%] | Block access |
| AND [Process = B] | |
| [Count of Failed Logins > X Within Y Seconds] | Move user to |
| | quarantine |
| [Protocol = X] AND [SOURCE ADDRESS = Y] | Issue alert to user |
| AND [Any Source Port] AND [Any Destination Port] | |
| [Count Of Record Affected > N] AND [Tool | Halt session |
| Used = %ABC%] | |
| Command = “Drop Database” AND User ID In | Block command |
| Application Users Group | |
| Count Of Activity > N AND Activity In “Off Work | Add user to strict |
| Hours” | monitoring list |
| Access To “System Resource” AND User In | Alert |
| Application Users Group | |

In step 214, the security policy generated in step 212, comprising at least one new and/or modified or updated security rule, may be applied within a production environment.

In some embodiments, the security policy and/or security rules may be functionally associated with a certain activity monitoring software which is configured to detect and/or prevent unauthorized access to data stored in a database environment. An example of such activity monitoring software is the IBM Guardium Data Activity Monitoring tool, available from International Business Machines Corporation of Armonk, New York, USA. The activity monitoring software may operate by monitoring traffic to and from the database, and applying one or more security policies to the observed traffic. Each security policy may include rules, such as manually-programmed rules, rules generated by a machine learning model based on examples of authorized and unauthorized traffic, or a combination of both.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

In the description and claims, each of the terms “substantially,” “essentially,” and forms thereof, when describing a numerical value, means up to a 20% deviation (namely, ±20%) from that value. Similarly, when such a term describes a numerical range, it means up to a 20% broader range—10% over that explicit range and 10% below it).

In the description, any given numerical range should be considered to have specifically disclosed all the possible subranges as well as individual numerical values within that range, such that each such subrange and individual numerical value constitutes an embodiment of the invention. This applies regardless of the breadth of the range. For example, description of a range of integers from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 4, and 6. Similarly, description of a range of fractions, for example from 0.6 to 1.1, should be considered to have specifically disclosed subranges such as from 0.6 to 0.9, from 0.7 to 1.1, from 0.9 to 1, from 0.8 to 0.9, from 0.6 to 1.1, from 1 to 1.1 etc., as well as individual numbers within that range, for example 0.7, 1, and 1.1.

The descriptions of the various embodiments of the present invention have been presented for purposes of illustration, but are not intended to be exhaustive or limited to the explicit descriptions. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise,” “include,” and “have,” as well as forms thereof, are not necessarily limited to members in a list with which the words may be associated.

Where there are inconsistencies between the description and any document incorporated by reference or otherwise relied upon, it is intended that the present description controls.

What is claimed is:

1. A computer-implemented method comprising:
automatically monitoring a honeypot trap environment, to capture activity data within said honeypot trap environment, wherein said honeypot trap environment comprises a plurality of software and hardware resources that are intended to attract attempts at unauthorized use of said honeypot trap environment;
automatically extracting, from said captured activity data, a plurality of attributes representing entities, events, and relations between said entities and events;
automatically applying an analytics suite to identify specific combinations of said attributes as representing a likelihood of being associated with an unauthorized intrusion attempt into said honeypot environment;
automatically assigning a risk score to each of said specific combinations, wherein said risk score reflect said likelihood of being associated with an unauthorized intrusion attempt into said honeypot environment; and
automatically generating at least one security rule for an intrusion detection and prevention system, based on at least one of said specific combinations.

2. The computer-implemented method of claim 1, wherein said honeypot trap environment comprises a plurality of software and hardware resources that are intended to attract attempts at unauthorized use of said honeypot trap environment.

3. The computer-implemented method of claim 1, wherein said entities comprise any one or more processes, objects, artifacts, files, directories, database servers, database tables, database collections, registries, sockets, and network resources.

4. The computer-implemented method of claim 1, wherein said events comprise any one or more of a system level or application level action that can be associated with one or more of said entities.

5. The computer-implemented method of claim 4, wherein said events are selected from the group consisting of: create directory, open file, read (‘SELECT’) from a database table, delete from a database table, stored procedure, modify data in a file, delete a file, copy data in a file, execute process, connect on a socket, accept connection on a socket, fork process, create thread, execute thread, start/stop thread, and send/receive data through socket or device.

6. The computer-implemented method of claim 1, wherein said attributes comprise connection attributes selected from the group consisting of: User ID, source program, client Internet Protocol (IP) address, server IP, domain name, Uniform Resource Locater (URL), Uniform Resource Identifier (URI), Unique IDentifier (UID), Media Access Control (MAC) address, DB (database) User, service name, client host, client operating system, user ID, port numbers and ranges, and protocol used.

7. The computer-implemented method of claim 1, wherein said attributes comprise activity attributes selected from the group consisting of: commands, SQL commands, objects accessed, number and frequency of probe requests within a specified time period, time of day of probe requests, data patterns, unique strings, Regex, keywords, specific syntax, login failures. authentication failures, and errors.

8. The computer-implemented method of claim 1, wherein said generating comprises one of: updating an existing security rule, and formulating a new security rule.

9. The computer-implemented method of claim 1, wherein said at least one security rule comprises (i) a conditional part comprising a set of conditions to be met for said security rule to be triggered, and (ii) an action part, comprising a set of actions to be taken when said security rule is triggered.

10. The computer-implemented method of claim 9, wherein said set of actions are one of: halting an involved process, issuing an alert, moving an involved process to a sandbox for further evaluation, dropping an on-going network session, halting an on-going disk operation, blocking one or more users or activities, quarantining one or more nodes or sections of a network, and adding users and other entities to a blacklist.

11. A system comprising:
at least one hardware processor; and
a non-transitory computer-readable storage medium having stored thereon program instructions, the program instructions executable by the at least one hardware processor to:
automatically monitor a honeypot trap environment, to capture activity data within said honeypot trap environment, wherein said honeypot trap environment comprises a plurality of software and hardware resources that are intended to attract attempts at unauthorized use of said honeypot trap environment,
automatically extract, from said captured activity data, a plurality of attributes representing entities, events, and relations between said entities and events,
automatically apply an analytics suite to identify specific combinations of said attributes as representing a likelihood of being associated with an unauthorized intrusion attempt into said honeypot environment,
automatically assign a risk score to each of said specific combinations, wherein said risk score reflect said likelihood of being associated with an unauthorized intrusion attempt into said honeypot environment, and
automatically generate at least one security rule for an intrusion detection and prevention system, based on at least one of said specific combinations.

12. The system of claim 11, wherein said honeypot trap environment comprises a plurality of software and hardware resources that are intended to attract attempts at unauthorized use of said honeypot trap environment.

13. The system of claim 11, wherein said entities comprise any one or more processes, objects, artifacts, files, directories, database servers, database tables, database collections, registries, sockets, and network resources.

14. The system of claim 11, wherein said events comprise any one or more of a system level or application level action that can be associated with one or more of said entities.

15. The system of claim 13, wherein said events are selected from the group consisting of: create directory, open file, read (‘SELECT’) from a database table, delete from a database table, stored procedure, modify data in a file, delete a file, copy data in a file, execute process, connect on a socket, accept connection on a socket, fork process, create thread, execute thread, start/stop thread, and send/receive data through socket or device.

16. The system of claim 11, wherein said attributes comprise connection attributes selected from the group consisting of: User ID, source program, client Internet Protocol (IP) address, server IP, domain name, Uniform Resource Locater (URL), Uniform Resource Identifier (URI), Unique IDentifier (UID), Media Access Control (MAC) address, DB (database) User, service name, client host, client operating system, user ID, port numbers and ranges, and protocol used.

17. The system of claim 11, wherein said attributes comprise activity attributes selected from the group consisting of: commands, SQL commands, objects accessed, number and frequency of probe requests within a specified time period, time of day of probe requests, data patterns, unique strings, Regex, keywords, specific syntax, login failures. authentication failures, and errors.

18. The system of claim 11, wherein said at least one security rule comprises (i) a conditional part comprising a set of conditions to be met for said security rule to be triggered, and (ii) an action part, comprising a set of actions to be taken when said security rule is triggered.

19. The system of claim 18, wherein said set of actions are one of: halting an involved process, issuing an alert, moving an involved process to a sandbox for further evaluation, dropping an on-going network session, halting an on-going disk operation, blocking one or more users or activities, quarantining one or more nodes or sections of a network, and adding users and other entities to a blacklist.

20. A computer program product comprising a non-transitory computer-readable storage medium having program instructions embodied therewith, the program instructions executable by at least one hardware processor to:
automatically monitor a honeypot trap environment, to capture activity data within said honeypot trap environment, wherein said honeypot trap environment comprises a plurality of software and hardware resources that are intended to attract attempts at unauthorized use of said honeypot trap environment;
automatically extract, from said captured activity data, a plurality of attributes representing entities, events, and relations between said entities and events;
automatically apply an analytics suite to identify specific combinations of said attributes as representing a likelihood of being associated with an unauthorized intrusion attempt into said honeypot environment;
automatically assign a risk score to each of said specific combinations, wherein said risk score reflect said likelihood of being associated with an unauthorized intrusion attempt into said honeypot environment; and
automatically generate at least one security rule for an intrusion detection and prevention system, based on at least one of said specific combinations.
